(19) United States
(12) Patent Application Publication
(10) Pub. No.: US 2018/0037140 A1
(43) Pub. Date: Feb. 8, 2018

(54) VEHICLE SEAT WITH EASY-ENTRY FUNCTION

(71) Applicant: BROSE FAHRZEUGTEILE GMBH & CO. KOMMANDITGESELLSCHAFT, COBURG, Coburg (DE)

(72) Inventors: Markus GOLLHARDT, Ermershausen (DE); Jawid RAHIMI, Muenchen (DE)

(21) Appl. No.: 15/554,690

(22) PCT Filed: Mar. 8, 2016
(86) PCT No.: PCT/EP2016/054879

§ 371 Date: Oct. 20, 2017

(30) Foreign Application Priority Data
Mar. 10, 2015 (DE) 10 2015 204 273.1

(51) Int. Cl. B60N 2/12; B60N 2/20; B60N 2/08

(52) U.S. Cl. CPC B60N 2/12; B60N 2/0881; B60N 2/20; B60N 2002/0236

(57) ABSTRACT

It is provided a vehicle seat having a seat portion, a backrest, a catch fitting which connects the backrest to the seat portion so as to be pivotable about a pivot axis and which retains the backrest in an upright seat position in a locked state and which allows the backrest to be pivoted and folded forward relative to the seat portion in an unlocked state, a longitudinal adjustment device for longitudinally adjusting the vehicle seat with a securing unit which retains the vehicle seat in a longitudinal position in a locked state and which allows a longitudinal adjustment of the vehicle seat in an unlocked state and an easy-entry control unit which is connected to an operating element which triggers an easy-entry function for unlocking the catch fitting and the securing unit. An electromechanical actuator unlocks the securing unit in a state controlled by the easy-entry control unit.

### CROSS-REFERENCE TO A RELATED APPLICATION

This application is a National Phase Patent Application of International Patent Application Number PCT/EP2016/054879, filed on Mar. 8, 2016, which claims priority of German Patent Application Number 10 2015 204 273.1, filed on Mar. 10, 2015, the contents of both of which are incorporated herein by reference.

### BACKGROUND

The invention relates to a vehicle seat with easy-entry function.

Such a vehicle seat has a seat portion, a backrest and at least one fitting which connects the backrest to the seat portion so as to be pivotable about a pivot axis. The fitting can be constructed in a manner known per se as a catch fitting or as a rotary fitting and allows pivoting of the backrest relative to the seat portion for the purposes of adjusting the backrest inclination.

In the context of an easy-entry function of the vehicle seat, the backrest is moved into a forward-pivoted position relative to the seat portion and the vehicle seat is moved into a front position via a longitudinal adjustment device, via which the vehicle seat is fixed, for example, to a vehicle floor, in a longitudinally displaceable manner so that easy and comfortable access to a seat located behind the vehicle seat is made possible for a vehicle occupant. In order to provide the easy-entry function, there is provided at an upper end of the backrest an easy-entry operating element, for example, in the form of a lever or push-button, which can be actuated in order to unlock the fitting and the longitudinal adjustment device. Consequently, the vehicle occupant can pivot the backrest forward with a handle by means of the easy-entry operating element and move the vehicle seat into a front position so that the space behind the vehicle seat is increased.

In a vehicle seat known from DE 10 2004 030 320 B4, an easy-entry actuation unit is connected via a Bowden cable to a catch fitting and with an additional Bowden cable to a longitudinal adjustment device of the vehicle seat. When the easy-entry actuation unit is actuated, the catch fitting, on the one hand, and, on the other hand, the longitudinal adjustment device are unlocked via the two Bowden cables so that the backrest can be pivoted into a folded-forward, so-called easy-entry position and the vehicle seat can be displaced into a front position.

In the case of a vehicle seat known from DE 103 53 242 B3, an easy-entry actuation unit which is arranged on a backrest is connected via an arm of a Bowden cable to a carrier lever which is arranged pivotably on a backrest and with another arm of the Bowden cable to a catch fitting. When the easy-entry actuation unit is actuated, the catch fitting is unlocked and the carrier lever is pivoted at the backrest into a position in which it moves into engagement with a carrier plate which is arranged concentrically with respect to the catch fitting when the backrest is pivoted and carries it. There is arranged at the carrier plate a Bowden cable which connects the carrier plate to a longitudinal adjustment device and which unlocks the longitudinal adjustment device when the backrest is pivoted forward.

Both easy-entry mechanisms require exact correspondence of the components for unlocking and locking the catch fitting and the longitudinal adjustment device and therefore tight tolerances in order to prevent incorrect operations and malfunctions. Furthermore, they are constructed in a comparatively complex manner, require a large number of components and cannot be readily retrofitted or integrated in present concepts particularly in the case of existing vehicle seats.

DE 10 2010 039 465 A1 discloses a vehicle seat having a simply constructed, robust actuation mechanism which is for providing the easy-entry function and which allows a backrest to be pivoted forward in conjunction with movement of the vehicle seat forward in order to make access behind the vehicle seat easier, and which can be retrofitted or integrated in present vehicle seat concepts in existing vehicle seats. This vehicle seat has a control unit having a control lever which is arranged on the seat portion and which can be adjusted between a passive position and an active position and which is connected to the longitudinal adjustment device in order to actuate the longitudinal adjustment device for providing the easy-entry function, and a carrier stop which is arranged on the backrest and which moves into active connection with the control lever when the backrest is pivoted in order to actuate the longitudinal adjustment device when the control lever is in the active position but does not move into active connection with the control lever when the control lever is in the passive position.

As a result of the arrangement of a control unit, a direct connection of the easy-entry actuation unit to the longitudinal adjustment device, for example, via a Bowden cable, is unnecessary. Instead, the actuation of the longitudinal adjustment device is brought about via the control unit in accordance with the pivot movement of the backrest, which has the additional advantage that the longitudinal adjustment device is actuated only when a user also really moves the backrest for pivoting forward.

In order to eliminate the disadvantages of a mechanical unlocking of a catch fitting or a longitudinal adjustment device, in particular the unlocking which is made more difficult as a result of an extension of a Bowden cable, there is known from DE 10 2006 030 728 A1 a vehicle seat having an electrical unlocking device comprising a lifting magnet or an actuation motor and an actuation member, in which a mechanical emergency unlocking device is further provided in order to unlock in the event of a voltage failure.

### SUMMARY

An object of the present invention is to provide a vehicle seat with an easy-entry function of the type mentioned in the introduction which can be universally used with small tolerance requirements and a protection from incorrect operations which is as great as possible using unlocking components which are present or standardized.

This object is achieved according to the invention with a vehicle seat with features as described herein.

The solution according to the invention provides for an easy-entry function for a vehicle seat, which function can be universally used with small tolerance requirements and a protection from incorrect operations which is as great as possible, in particular using unlocking components which are present or standardized.

As a result of the arrangement of an electromechanical actuator which is controlled by the easy-entry control unit and which is connected to a securing unit via a mechanical interface in order to unlock and lock the longitudinal adjustment device and which unlocks the longitudinal adjustment device only in the event of a predetermined pivot angle when the backrest is folded forward and which locks it in the longitudinal position after the end of the easy-entry function and after the backrest has been folded back into the upright seat position, the unlocking is substantially independent of mechanical transmission members so that no tolerances have to be taken into consideration when the transmission members are dimensioned and thereby malfunctions are avoided. Since the electromechanical actuator is connected to an interface of the securing unit, the electromechanical actuator can readily be used in place of a mechanical unlocking device so that one and the same securing unit can be used in conjunction with both a mechanical and an electromechanical unlocking and locking of the longitudinal adjustment device.

The electromechanical actuator is connected either to a current supply device and controlled via a control line by the easy-entry control unit, or is connected directly by the easy-entry control unit to the current supply device or voltage source in order to unlock and lock the securing unit upon receipt of a sensor signal of a sensor which is arranged in the pivot range of the backrest.

In a first embodiment, the electromechanical actuator comprises an electromotive drive and a Bowden cable which is connected, on the one hand, to an output of the electromotive drive and, on the other hand, to the interface of the securing unit.

The combination of an electromotive drive with a Bowden cable allows the drive to be positioned at a favorable location of the vehicle seat and the connection with respect to the interface of the securing unit to be brought about with a Bowden cable which can have such short dimensions that extensions of the Bowden cable are unimportant so that a reliable unlocking action is ensured.

The electromotive drive is preferably arranged at the inner side of a lateral seat portion of the vehicle seat by way of fixing means which are inserted from the outer side of the lateral seat portion so that the electromotive drive can be positioned in a protected manner and assembled in a simple manner.

Since relatively large forces are required for unlocking and locking the longitudinal adjustment device, and therefore relatively large torques which have to be applied by the electromotive drive are required, there is the risk that substantial forces may act on the Bowden cable in the unlocking end position and may lead to damage or destruction of the Bowden cable. In order to prevent inadvertent extension, damage or destruction of the Bowden cable, according to another feature of the invention the Bowden cable is fixed to a pivot lever which is connected to the output of the electromotive drive and the pivot angle of which is limited by stops.

In a second embodiment, the electromechanical actuator comprises an electromotive drive, the output of which is directly connected to the interface of the securing unit.

The direct connection of the electromotive drive to the interface of the securing unit overcomes the risk of an extension, even only a small extension, of a Bowden cable which is provided as a connection member between the output of the electromotive drive and the interface and therefore an impairment of the function and the risk of undesirable noise which is caused by movements of the Bowden cable. Furthermore, no friction can occur between the tension means and the Bowden sheath.

When the output of the electromotive drive is connected directly to the securing unit, the electromotive drive is preferably fixed to the outer side of a lateral seat portion of the vehicle seat and the output of the electromotive drive is fitted through a hole of the lateral seat portion and is connected to a pivot lever which cooperates with a pivot pin of the securing unit for locking and unlocking the longitudinal adjustment device.

The longitudinal adjustment device has an upper rail which is connected to the seat portion, a lower rail for displaceable support of the upper rail and an actuation lever for longitudinally adjusting the vehicle seat and can produce a so-called dynamic stop which is used to limit the displacement path to a longitudinal adjustment comfort range during normal longitudinal adjustment of the vehicle seat so that the vehicle seat cannot be displaced beyond this longitudinal adjustment comfort range in the event of such a normal adjustment. When the longitudinal adjustment device is actuated in the context of the easy-entry function, however, this dynamic stop becomes inactive so that the vehicle seat can also be moved beyond the longitudinal adjustment comfort range into a position displaced forward in order to maximize the space for access behind the vehicle seat.

Accordingly, a stop lever of the securing unit, which stop lever contains the mechanical interface and is pivotably fixed to the upper rail or lower rail, is provided as a dynamic stop which has a stop position, in which it is not pivoted in the context of an easy-entry function, and a release position, in which it is pivoted in the context of the easy-entry function. The stop lever limits the longitudinal adjustment path of the upper rail and lower rail relative to each other in the stop position with a stop on the other rail (that is to say, on the lower rail if the stop lever is fitted to the upper rail or on the upper rail if the stop lever is fitted to the lower rail) but does not cooperate with the stop in the release position.

In the context of a normal longitudinal adjustment independent of the easy-entry function, the stop lever is located in a normal use position corresponding to the stop position, in which it cooperates with a fixed stop in order to limit the adjustment path of the upper rail and lower rail relative to each other. If, however, the easy-entry control unit is actuated in the context of the easy-entry function and the stop lever, when the backrest is pivoted forward, pivots by means of the electromechanical actuator into the release position, in which it cannot cooperate with the stop, the vehicle seat can be displaced beyond the stop.

The securing unit of the longitudinal adjustment device has a securing lever which is pivotably arranged on the upper rail and which has comb-like securing teeth in order to secure the longitudinal position of the upper rail relative to the lower rail and a connection element which is pivotably arranged on the upper rail and which connects the stop lever to the securing lever and which can be moved into active connection with the securing lever in order to secure the longitudinal adjustment device and to release the securing of the longitudinal adjustment device.

The mechanical interface of the stop lever and therefore of the securing unit is formed either by a connection which is spaced apart from the pivot axle of the stop lever for the Bowden cable or by the pivot axle of the stop lever itself, which axle is connected to the output of the electromotive drive.

In order to apply the forces necessary for reliably unlocking and locking the securing unit by the electromechanical actuator and therefore the necessary torques by the electromotive drive, the electromotive drive has an electric motor and a two-stage reduction gear mechanism, whose first reduction gear stage comprises a self-locking worm gear having a driving worm which is connected to the motor shaft of the electric motor, a spiral-toothed gear wheel which is in engagement with the tooth arrangement of the driving worm and an eccentric which is connected to the spiral-toothed gear wheel while the second reduction gear stage is constructed as a swash wheel gear mechanism having a shaft which is fitted through a hole of the eccentric, an output wheel which is supported concentrically on the shaft and which has an inner tooth arrangement, an output pinion which is connected to the output wheel, a swash wheel whose outer tooth arrangement cooperates with the inner tooth arrangement of the output wheel and a guide device for the swash wheel.

The easy-entry control unit is preferably constructed as a modular unit having a retention plate which is fixed to the backrest or the seat portion by screwing, riveting, clip-fitting or welding or other suitable fixing means, and which optionally contains the operating element for triggering the easy-entry function. As a result of the modular construction type, the construction of the vehicle seat and in particular the assembly thereof are simplified, wherein, for example, the easy-entry control unit can be readily fixed to an adapter plate of the backrest or the seat portion, for example, and can be clip-fitted to the adapter plate by means of catch elements.

In order to prevent the backrest from undesirably pivoting backward out of the easy-entry position when the backrest is pivoted forward and when the vehicle seat is moved forward, there may further be provided a backrest securing unit for securing the backrest in a forward-pivoted position in accordance with DE 10 2010 039 465 A1.

In the context of the easy-entry function, the vehicle seat is displaced into a front position in order to increase the space behind the vehicle seat, in particular for easy, comfortable access. After the access has been achieved or if the space is no longer required, the vehicle seat is then repositioned from the easy-entry position thereof, wherein advantageously the vehicle seat is intended to move into a preferred position for use during repositioning in a simple manner which is easy to handle. To this end, there may be provided a so-called memory catch which is arranged in a pretensioned manner on the connection element of the longitudinal adjustment device in such a pivotable manner that the memory catch is brought into abutment with an abutment portion of the lower rail when the connection element is actuated in the context of the easy-entry function in order to lock the upper rail when a predefined catch position with the lower rail is reached. To this end, the memory catch may have at least one catch tooth which is constructed to move into engagement with a recess in the lower rail when a catch position is reached.

The memory catch is used to achieve locking of the vehicle seat in a preferred longitudinal position during repositioning of the vehicle seat from the forward-pivoted, forward-displaced easy-entry position. To this end, the memory catch is brought into an engagement position, that is to say, into abutment with an abutment portion on the lower rail of the longitudinal adjustment device of the vehicle seat during pivoting of the connection element for actuation of the longitudinal adjustment device in the context of the easy-entry function and is pivoted relative to the connection element and pressed with pretensioning against the abutment portion so that the memory catch slides along the abutment portion during displacement of the vehicle seat.

### BRIEF DESCRIPTION OF THE DRAWINGS

The notion forming the basis of the invention is intended to be explained in greater detail below with reference to the embodiments illustrated in the Figures.

FIG. 1 is an isometric view of a vehicle seat having a seat portion and a backrest which is pivotably connected to the seat portion via two fittings and which can be folded forward in conjunction with a forward displacement of the vehicle seat in the context of an easy-entry function.

FIG. 2 is an isometric view of an inner side of the vehicle seat according to FIG. 1 having an electromechanical actuator which comprises an electromotive drive and a Bowden cable in order to unlock a longitudinal adjustment device.

FIG. 3 is an isometric view to an enlarged scale of the electromechanical actuator which is connected to an interface of the securing unit.

FIG. 4 is a side view of the electromechanical actuator which is connected to the interface of the securing unit.

FIG. 5 is an isometric view of the electromotive drive and Bowden cable.

FIGS. 6 and 7 are side views of the functional elements of the securing unit and a portion of the longitudinal adjustment device in a first embodiment of a longitudinal adjustment device with a dynamic stop which is intended to be actuated in the context of the easy-entry function.

FIG. 8 is an isometric view of a second embodiment of an electromechanical actuator comprising an electromotive drive which is directly connected to a stop lever of the securing unit.

FIG. 9 is an isometric view of the electromotive drive connected to a lateral seat portion according to FIG. 8.

FIG. 10 is an isometric view to an enlarged scale of the functional elements of the securing unit according to FIG. 8.

FIG. 11 is an isometric view of the connection of the electromotive drive to the stop lever of the securing unit according to FIGS. 8-10.

FIG. 12 is a longitudinal section through the second embodiment of the electromechanical actuator and the functional elements of the securing unit according to FIGS. 8-11.

FIG. 13 is a perspective exploded view of the subassemblies of the electromotive drive of FIGS. 2-12.

### DETAILED DESCRIPTION

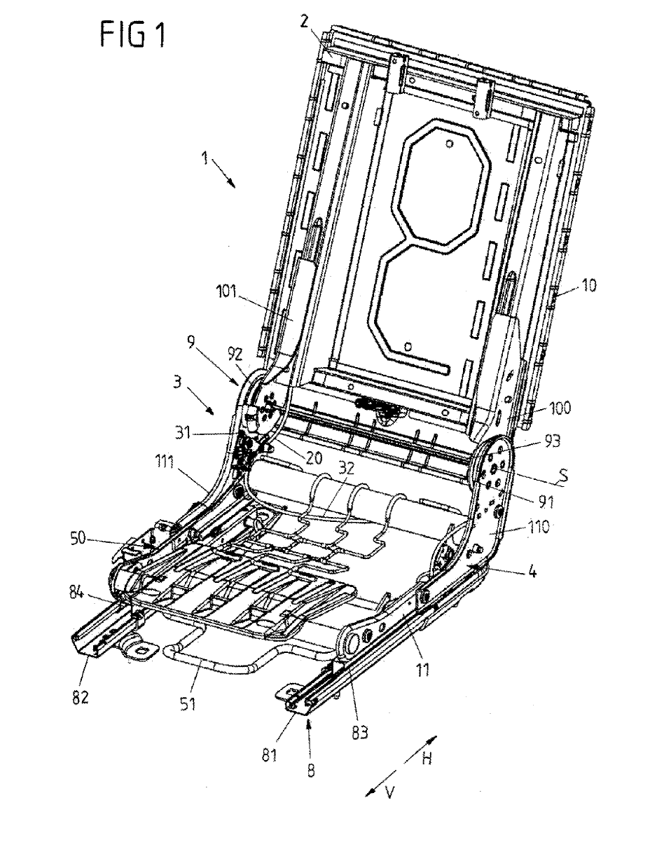

FIG. 1 is a perspective overview of a vehicle seat 1 which has a backrest 10 which is pivotably connected to a seat portion 11 via two catch fittings 91, 92. The catch fittings 91, 92 are connected to each other via a shaft 93 which extends along a pivot axis S of the backrest 10, wherein the catch fittings 91, 92 can be actuated by rotating the shaft 93 in order to pivot the backrest 10 relative to the seat portion 11.

The seat portion 11 can be connected to a vehicle floor displaceably in a longitudinal direction V, H of a vehicle via a longitudinal guide 8 which comprises two lower rails 81, 82 which are intended to be arranged on a vehicle floor and upper rails 83, 84 which are supported in a longitudinally displaceable manner on the lower rails 81, 82, and has a longitudinal adjustment device 5 which is only indicated in FIG. 1 and via which the upper rails 83, 84 can be locked to the lower rails 81, 82 in order to lock the vehicle seat 1 in a longitudinal position. In order to longitudinally adjust the vehicle seat 1, the longitudinal adjustment device 5 can be actuated via an actuation lever 51 which is arranged at the front side on the seat portion 11.

The catch fittings 91, 92 each have a fitting portion which is fixed to a seat portion and which is connected to lateral seat portions 110, 111 of the seat portion 11 and a fitting portion which is fixed to a backrest and which is connected to frame portions 100, 101 of the backrest 10, which can be pivoted relative to each other in order to pivot the backrest 10.

In order to afford access in such a vehicle seat 1 to a space located behind the vehicle seat 1, for example, to an additional bench type seat of the vehicle arranged behind the vehicle seat 1, the vehicle seat 1 has a so-called easy-entry function, in the context of which the backrest 10 can be moved into a position pivoted forward and the vehicle seat 1 can be moved into a position displaced forward when the backrest 10 is pivoted forward. In order to provide this easy-entry function, the vehicle seat 1 has an easy-entry operating unit 2 which is generally arranged at an upper end of the backrest 10, an easy-entry control unit 3, a backrest securing unit 4 which cooperates with the easy-entry control unit 3 and—in this embodiment—a so-called memory unit 50 which cooperates with the longitudinal adjustment device 5 in order to lock the vehicle seat 1 in a front comfort position during repositioning of the vehicle seat 1 from an easy-entry position. The easy-entry control unit 3 may optionally be arranged in the region of the catch fitting 92 or in a state combined with the easy-entry operating unit 2 at the upper end of the backrest 10.

A characteristic of the vehicle seat 1 illustrated in FIG. 1 is that the individual units which are arranged on the vehicle seat 1 in order to provide the easy-entry function are constructed in a modular manner and connected via Bowden cables and/or control lines to the easy-entry control unit 3. In this case, the units are constructed in such a manner that they can be retrofitted in an existing vehicle seat 1 or readily integrated in an existing vehicle seat concept without the construction and the operation of the vehicle seat 1 otherwise substantially changing. In the same manner, the control of an electromechanical actuator may be provided for instead of mechanical actuation of an unlocking device by the electromechanical actuator being connected to the interface of a securing unit of the backrest securing unit 4 and/or longitudinal adjustment device 5 and being connected via a control line or current supply line to the easy-entry control unit 3.

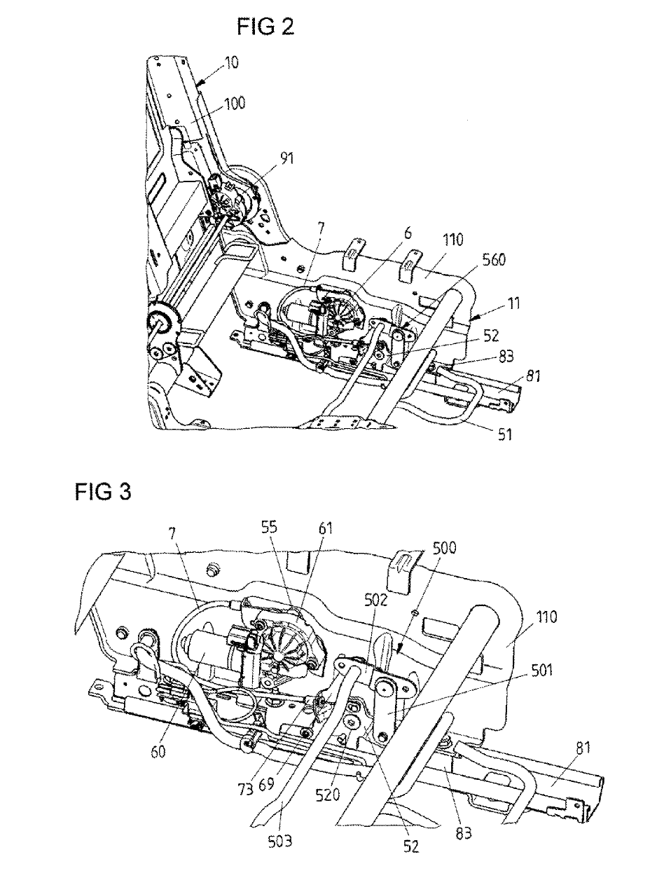

The operation of a first embodiment of the unlocking and locking of the longitudinal adjustment device 5 by means of an electromechanical actuator 6, 7 which is connected to an interface of a securing unit of the longitudinal adjustment device 5 is explained below with reference to FIGS. 2 to 7, wherein where applicable the backrest securing unit 4 and/or the memory unit 50 may be dispensed with in order to provide a cost-effective vehicle seat 1 with a simple easy-entry function. In this instance, the vehicle seat 1 with the described easy-entry function and in particular the easy-entry control unit 3 allows individual modular units 2, 4, 5, 50 to be combined with each other in a modular manner and where applicable also to be dispensed with.

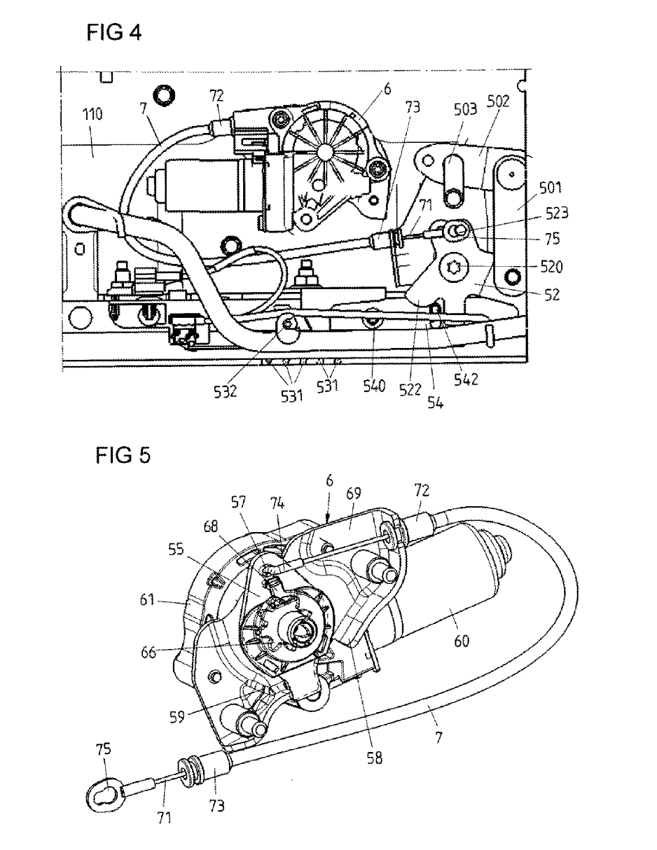

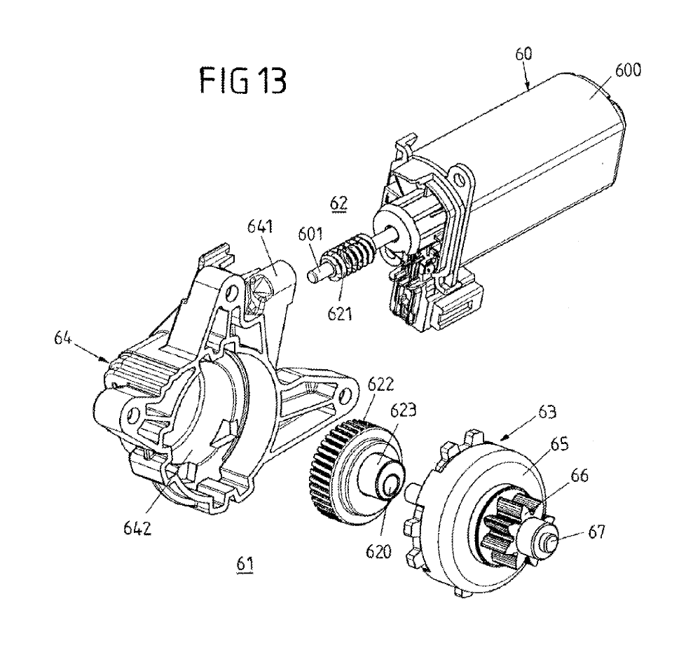

FIG. 2 is an isometric overall view and FIG. 3 is an isometric part-view to an enlarged scale of the longitudinal adjustment device 5 and FIG. 4 is a side view of the connection of an electromechanical actuator 6, 7 to the structural elements of a securing unit of the longitudinal adjustment device 5 while FIG. 5 is an isometric illustration of the electromechanical actuator 6, 7. The electromechanical actuator 6, 7 comprises a Bowden cable 7 and an electromotive drive 6 which is illustrated below in detail in FIG. 13 and which has an electric motor 60 and a gear mechanism 61. The tension means 71 of the Bowden cable 7 is connected, on the one hand, to an eyelet 57 of a pivot lever 55 via a tension means connection 74 and, on the other hand, to the interface of the securing unit of the longitudinal adjustment device 5 via a tension means connection 75. Whereas one Bowden sheath fixing member 72 according to FIG. 5 is fixed to a retention plate 69 of the electromotive drive 6, the other Bowden sheath fixing member 73 according to FIGS. 2 to 4 is connected to an assembly portion of the securing unit of the longitudinal adjustment device 5 or the lateral seat portion 110.

The gear mechanism 61 of the electromechanical actuator 6 has at the output side an output pinion 66 which is connected to the pivot lever 55 via a carrier 68 which engages in a hole of the pivot lever 55. In order to limit the pivot angle of the pivot lever 55 and therefore to limit the tension force applied to the tension means 71 of the Bowden cable 7, stops 58, 59 are constructed on the retention plate 69 of the electromechanical actuator 6.

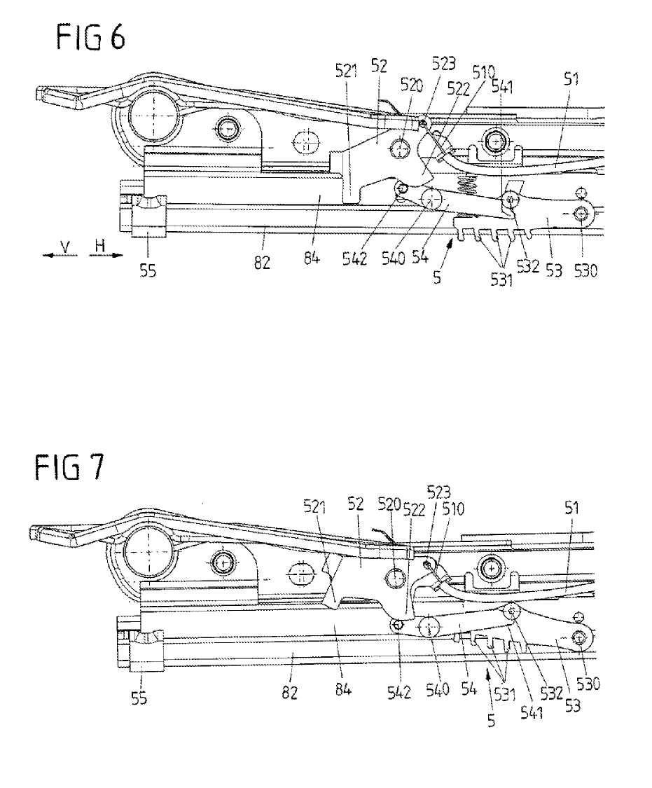

The interface of the connection of the electromechanical actuator 6 with the securing unit of the longitudinal adjustment device 5 is constructed according to FIGS. 2 to 4 with respect to the Bowden sheath on the retention plate 69 and with respect to the tension means 71 in order to introduce the unlocking force on a stop lever 52, the function of which is explained in greater detail with reference to FIGS. 6 and 7 in connection with the additional structural elements of the securing unit of the longitudinal adjustment device 5.

In order to connect the securing unit (which is actuated by means of the electromechanical actuator 6) of the left-hand vehicle seat side to the securing unit of the opposite vehicle seat side, a connection mechanism 500 is according to FIGS. 2 and 3, having a first connection lever 501 which is articulated to the stop lever 52, a second connection lever 502 which is articulated to the first connection lever 501 and the retention plate 69 and a connection rod 503, which connects the second connection lever 502 of the left vehicle seat side to the second connection lever of the right vehicle seat side in order to unlock the longitudinal adjustment device of the right vehicle seat side.

The easy-entry control unit 3 serves to actuate the securing unit of the longitudinal adjustment device 5 in the context of the easy-entry function so that the vehicle seat 1 can be moved into a front position when the easy-entry operating unit 2 is actuated in order to increase the space behind the vehicle seat 1 for simple, comfortable access or to increase the storage room.

FIGS. 6 and 7 show in an embodiment a longitudinal adjustment device 5 which has a securing lever 53 which is pivotably supported on the upper rail 84 about a pivot axis 530 and which is in engagement by means of comb-like securing teeth 531 in a locking position illustrated in FIG. 6 with recesses which are correspondingly provided in the lower rail 82, and which thereby locks the upper rail 84 to the lower rail 82 and retains the vehicle seat 1 in the longitudinal position thereof. The securing lever 53 is connected to the actuation lever 51 which is illustrated in FIGS. 1 and 2 and can be moved for normal adjustment of the longitudinal position of the vehicle seat 1 via the actuation lever 51 from the locked position illustrated in FIG. 6 into the unlocked position which is illustrated in FIG. 7 and in which the upper rail 84 is no longer locked with respect to the lower rail 82 and consequently the vehicle seat 1 can be displaced longitudinally. The securing lever 53 is pretensioned in the locked position thereof according to FIG. 6 via a suitable resilient element so that, after the actuation lever 51 has been released, the securing lever 53 automatically moves back into the locked position thereof according to FIG. 6.

The longitudinal adjustment device 5 further has a stop lever 52 which is arranged on the upper rail 84 so as to be able to pivot about a pivot axle 520 and is connected to the tension means 71 of the Bowden cable 7 with a connection 523 which forms the interface with respect to the electromechanical actuator 6, 7, which tension means 71 is connected according to FIGS. 2 to 5, on the one hand, to the pivot lever 55 at the output of the electromotive drive 6 and, on the other hand, to the connection 523 of the stop lever 52 and consequently connects the stop lever 52 to the electromechanical actuator 6, 7.

The stop lever 52 is used in the normal position illustrated in FIG. 6 to provide a so-called dynamic stop for the longitudinal adjustment device 5. Thus, in the event of normal actuation of the securing lever 53 by means of the actuation lever 51, the vehicle seat 1 can be displaced only until the stop lever 52 which is arranged on the upper rail 84 comes into contact, by means of a stop projection 521 provided at a front end, with a stop 55 which is provided in a fixed manner on the lower rail 82. The stop lever 52 on the upper rail 84 consequently limits together with the stop 55 on the lower rail 82 the longitudinal adjustment path of the vehicle seat 1 and defines the longitudinal adjustment comfort range, within which the vehicle seat 1 can be moved during normal longitudinal adjustment. During normal adjustment by actuating the securing lever 53, the vehicle seat 1 cannot be displaced forward in the direction V beyond the front position which is defined by the stop lever 52 and the stop 55.

During actuation in the context of the easy-entry function, however, the stop lever 52 is pivoted via the Bowden cable 7 into the position illustrated in FIG. 7 and acts via a projection 522 and a pin 542 on a connection element 54 which is pivotably supported on the upper rail 84 about a pivot axis 540 and which is pivoted about the pivot axis 540 by action of the stop lever 52 and which acts on a stop pin 532 of the securing lever 53 via a projection 541 in order to move the securing lever 53 into the unlocked position thereof in the manner illustrated in FIG. 7. Since the stop lever 52 has been pivoted into the position illustrated in FIG. 7, the stop projection 521 provided on the stop lever 52 has been lifted relative to the stop 55 of the lower rail 82 so that, in the event of longitudinal adjustment of the vehicle seat 1, the stop projection 521 does not move into abutment with the stop 55 and the vehicle seat 1 can consequently be displaced beyond the front position defined by the stop 55. In the context of the easy-entry function, consequently, the vehicle seat 1 can be displaced forward beyond the longitudinal adjustment comfort range so that the space behind the vehicle seat 1 can be increased to a maximum extent.

The longitudinal adjustment device 5 can cooperate with a memory unit 50 which is used to lock the vehicle seat 1 in a preferred longitudinal position within the longitudinal adjustment comfort range in the event of repositioning of the vehicle seat 1 from an easy-entry position (in which the vehicle seat 1 is generally displaced forward and the backrest 10 is pivoted forward). In this case, the securing lever 53 of the longitudinal adjustment device 5 moves into engagement with the lower rail 82 and locks the upper rail 84 relative to the lower rail 82, wherein at the same time the connection lever 54 pivots back about the pivot axis 540 into the position illustrated in FIG. 6.

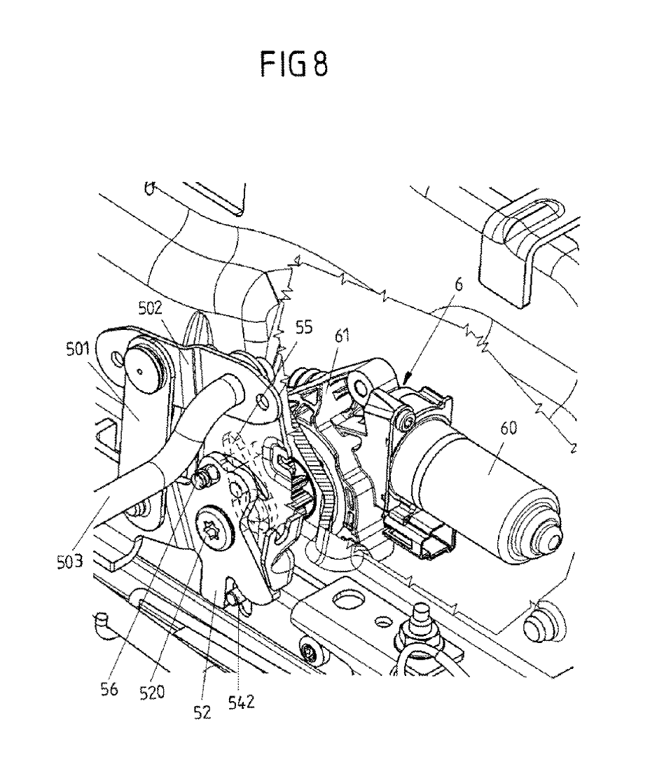

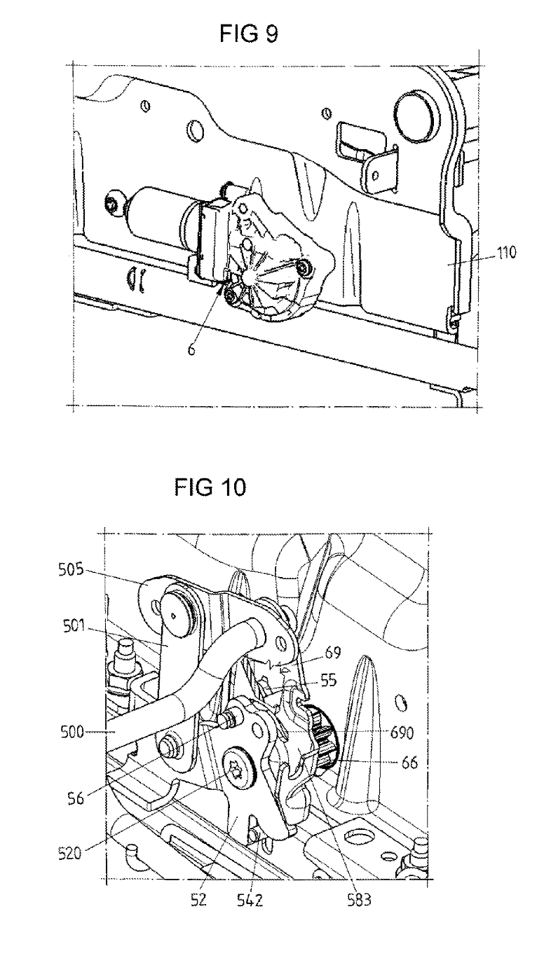

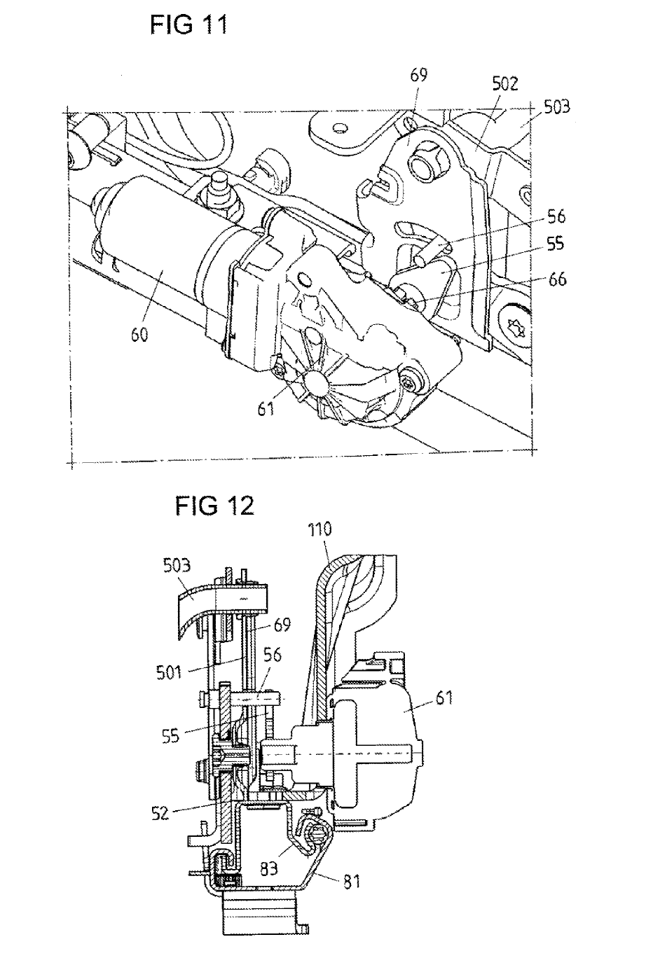

FIGS. 8 to 12 illustrate a second embodiment of an electromechanical actuator for unlocking a longitudinal adjustment device 5, which embodiment differs from the above-described embodiment (which is illustrated in FIGS. 2 to 7) of an electromechanical actuator in that the electromechanical actuator comprises an electromotive drive 6 which is directly connected to the interface of the securing unit. Therefore, it is not necessary to have a Bowden cable which connects the output of the electromotive drive 6 to the interface of the securing unit of the longitudinal adjustment device 5 so that no additional measures are required to prevent an undesirable extension of a Bowden cable and to prevent undesirable noise as a result of a movable Bowden cable and friction losses between the Bowden sheath and the tension means of a Bowden cable do not occur.

In this second embodiment, a shaft 67 of the electromotive drive 6 is directly connected to the pivot axle 520 of the stop lever 52 while the output pinion 66 of the electromotive drive 6 is connected to a pivot lever 55 which is applied to a pivot pin 56 of the stop lever 52 in order to pivot the stop lever 52. The pivot pin 56 engages through a slot 690 of the retention plate 69, which slot extends radially around the pivot axle 520, in order to receive the articulation of the connection rod 503 with respect to the second connection lever 502 in order to connect the securing unit (illustrated in FIGS. 8 to 12) of one vehicle seat side to the securing unit of the opposite vehicle seat side. In the event of control of the electromotive drive 6 by the easy-entry control unit 3, the output pinion 66 is rotated in one or other direction and thereby pivots the pivot lever 55 in one or other direction in order to pivot the stop lever 52 and to unlock the longitudinal adjustment device 5 as described above.

FIG. 13 is a perspective exploded view of an electromotive drive 6 which can preferably be used as an electromechanical actuator and which has a drive motor 60 having a motor housing 600 and a motor shaft 601, on which a driving worm 621 of a self-locking worm gear 62 is fixed in a rotationally secure manner. A housing shell 64 of a drive housing has a hollow-cylindrical first recess 641 for receiving the driving worm 621 of the worm gear 62 and to support the motor shaft 601 of the drive motor 60 and a pot-like second recess 642 for receiving a spiral-toothed gear wheel 622 of the worm gear 62 and an eccentric 623 which is connected in one piece to the spiral-toothed gear wheel 622 and which acts as a connection member between the first reduction gear stage comprising the worm gear 62 and a second reduction gear stage which is in the form of a swash gear mechanism 5. A shaft 67, which engages through the components of the swash gear mechanism 63 and which has an output pinion 66 at the output side of the swash gear mechanism 63 and therefore at the output side of the electromotive drive 6, is fitted in a hole 620 of the eccentric 623.

The housing shell 64 has a plurality of flange arms which project radially from the pot-like second recess 642 and which have end-side assembly openings which are used to receive fixing means for connecting the housing shell 64 and therefore the electromotive drive 6 to the lateral seat portion 110 of the vehicle seat 1. The swash gear mechanism 5 forms a closed structural unit which contains a pot-like housing cover 65 which closes the pot-like second recess 642 of the housing shell 64.

The swash wheel gear mechanism 63 which forms the second reduction gear stage of the reduction gear mechanism has in a manner known per se, for example, an output wheel which has an inner tooth arrangement and which is connected to the output pinion 66 which actuates via the pivot lever 55 either the Bowden cable 7 or the stop lever 52. The outer tooth arrangement of a swash wheel meshes with the inner tooth arrangement of the output wheel, wherein the number of teeth of the outer tooth arrangement of the swash wheel differs from the inner tooth arrangement of the output wheel by at least one tooth. A guide device which is formed, for example, from a plate-like cross-like sliding member and an annular guide plate serves to guide the swash wheel in a plane without inherent rotation of the swash wheel which consequently carries out a swash movement on a circular path. As a result of the eccentric movement of the eccentric 623 about the shaft 67 and the number of teeth of the outer tooth arrangement of the swash wheel, which number is lower by at least one tooth, with respect to the inner tooth arrangement of the output wheel, the swash wheel carries out a movement which is oscillating but rotationally secure about the shaft 67, wherein the speed of the output wheel and therefore of the output pinion 66 is substantially lower as a result of the high reduction effect than the rotation speed of the swash wheel.

The notion forming the basis of the invention is not limited to the embodiments described above but instead can also be implemented in embodiments of a different type in principle. For example, the electromechanical actuator 6 or 6, 7 can also be used with respect to the unlocking of the rear end of a vehicle seat to pivot the entire vehicle seat about a front articulation. Furthermore, all the units 2, 3, 4, 5, 50 do not necessarily have to be used in conjunction with each other but instead, for example, a vehicle seat 1 may also have only an easy-entry control unit 3 and a longitudinal adjustment device 5 but no backrest securing unit 4 and no memory unit 50.

### LIST OF REFERENCE NUMERALS

1 Vehicle seat
2 Easy-entry operating element
3 Easy-entry control unit
4 Backrest securing unit
5 Longitudinal adjustment device
6 Electromotive drive
7 Bowden cable
8 Longitudinal guide
9 Inclination adjustment device
10 Backrest
11 Seat portion
20 Bowden cable, cable
31 Sensor element
32 Electrical line
50 Memory device
51 Actuation lever
52 Stop lever
53 Securing lever
54 Connection element
55 Pivot lever
56 Pivot pin
57 Eyelet
58, 59 Stop
60 Electric motor
61 Gear mechanism
62 Worm gear
63 Swash wheel gear mechanism
64 Housing shell
65 Housing cover
66 Output pinion
67 Shaft
68 Carrier
69 Retention plate
71 Tension means
72, 73 Bowden sheath fixing member
74, 75 Tension means connection
81, 82 Lower rail
83, 84 Upper rail
91, 92 Catch fitting
93 Shaft
100,101 Frame portion
110,111 Lateral seat portion
500 Connection mechanism
501 1^{st} connection lever
502 2^{nd} connection lever
503 Connection rod
520 Pivot axle
521 Stop projection
522 Projection
523 Connection
530 Pivot axis
531 Securing teeth
532 Stop pin
540 Pivot axis
541 Projection
542 Pin
600 Motor housing
601 Motor shaft
620 Hole
621 Driving worm
622 Spiral-toothed gear wheel
623 Eccentric
641 1^{st} recess
642 2^{nd} recess
H Backward direction
S Backrest pivot axis
V Forward direction

1. A vehicle seat having
a seat portion,
a backrest,
a catch fitting which connects the backrest to the seat portion so as to be pivotable about a pivot axis and which retains the backrest in an upright seat position in a locked state and which allows the backrest to be pivoted and folded forward relative to the seat portion in an unlocked state,
a longitudinal adjustment device for longitudinally adjusting the vehicle seat with a securing unit which retains the vehicle seat in a longitudinal position in a locked state and which allows a longitudinal adjustment of the vehicle seat in an unlocked state,
an easy-entry control unit which is connected to an operating element which triggers an easy-entry function for unlocking the catch fitting and the securing unit, and
an electromechanical actuator which unlocks the securing unit in a state controlled by the easy-entry control unit via a mechanical interface in order to provide the easy-entry function when a predetermined pivot angle is exceeded when the backrest is folded forward and which locks it in the longitudinal position after the end of the easy-entry function and after the backrest has been folded back into the upright seat position.

2. The vehicle seat as claimed in claim 1, wherein the easy-entry control unit is connected to the electromechanical actuator via an electrical line which is constructed as a control and/or current supply line and via a sensor line to at least one sensor element, which is arranged at a predetermined pivot angle in the pivot range of the backrest and which outputs a sensor signal to the easy-entry control unit.

3. The vehicle seat as claimed in claim 1, wherein the mechanical interface can be connected both to the electromechanical actuator and to a force transmission element in order to manually lock and unlock the securing unit.

4. The vehicle seat as claimed in claim 1, wherein the electromechanical actuator comprises an electromotive drive and a Bowden cable which is connected, on the one hand, to an output of the electromotive drive and, on the other hand, to the interface of the securing unit.

5. The vehicle seat as claimed in claim 4, wherein the Bowden cable is fixed to a pivot lever which is connected to the output of the electromotive drive and the pivot angle of which is limited by stops.

6. The vehicle seat as claimed in claim 4, wherein the electromotive drive is arranged at the inner side of a lateral seat portion of the vehicle seat and is connected to the lateral seat portion by way of fixing means which are inserted from the outer side of the lateral seat portion.

7. The vehicle seat as claimed in claim 1, wherein the electromechanical actuator comprises an electromotive drive, the output of which is directly connected to the interface of the securing unit.

8. The vehicle seat as claimed in claim 7, wherein the electromotive drive is fixed to the outer side of a lateral seat portion of the vehicle seat and the output of the electromotive drive is fitted through a hole of the lateral seat portion and is connected to a pivot lever which cooperates with a pivot pin of the securing unit for locking and unlocking the longitudinal adjustment device.

9. The vehicle seat as claimed in claim 1, wherein the longitudinal adjustment device has
an upper rail which is connected to the seat portion,
a lower rail on which the upper rail is displaceably supported,
and an actuation lever for longitudinally adjusting the vehicle seat, and the securing unit of the longitudinal adjustment device has
a stop lever which contains the mechanical interface and which is pivotably fixed to the upper rail or lower rail,
a securing lever which is pivotably arranged on the upper rail and which has securing teeth in order to secure the longitudinal position of the upper rail relative to the lower rail and
a connection element which is pivotably arranged on the upper rail and which connects the stop lever to the securing lever and which can be moved into active connection with the securing lever in order to secure the longitudinal adjustment device and to release the securing of the longitudinal adjustment device.

10. The vehicle seat as claimed in claim 9, wherein the stop lever can be pivoted about a pivot axle and cooperates in a non-pivoted stop position via a stop projection with a stop on the lower rail or upper rail in order to limit the longitudinal adjustment path of the upper rail and lower rail and does not cooperate with the stop in a release position pivoted with respect to the stop position after triggering of the easy-entry function via the stop projection and which acts with a projection on a pin of the connection element in order to release the securing of the longitudinal adjustment device.

11. The vehicle seat as claimed in claim 9, wherein the mechanical interface of the stop lever is formed by a connection of the Bowden cable with spacing from the pivot axle of the stop lever.

12. The vehicle seat as claimed in claim 9, wherein the mechanical interface of the stop lever is formed by the pivot axle of the stop lever, which axle is connected to the output of the electromotive drive.

13. The vehicle seat as claimed in claim 9, wherein the mechanical interface of the stop lever comprises a pivot lever which is connected to the output pinion of the electromotive drive or a pivot pin which is connected to the pivot lever.

14. The vehicle seat as claimed in claim 4, wherein the electromotive drive has an electric motor and a two-stage reduction gear mechanism, whose first reduction gear stage comprises a self-locking worm gear having a driving worm which is connected to the motor shaft of the electric motor, a spiral-toothed gear wheel which is in engagement with the tooth arrangement of the driving worm and an eccentric which is connected to the spiral-toothed gear wheel and whose second reduction gear stage is constructed as a swash wheel gear mechanism having a shaft which is fitted through a hole of the eccentric, an output wheel which is supported concentrically on the shaft and which has an inner tooth arrangement, an output pinion which is connected to the output wheel, a swash wheel whose outer tooth arrangement cooperates with the inner tooth arrangement of the output wheel and a guide device for the swash wheel.
